(19) United States
(12) Patent Application Publication
(10) Pub. No.: US 2009/0112951 A1
(43) Pub. Date: Apr. 30, 2009

(54) APPARATUS AND METHOD OF MANAGING FILES AND MEMORY DEVICE

(76) Inventors: Seung-Woo Ryu, Seoul (KR); Moon-Sang Kwon, Seoul (KR); Hyun-Joo Ahn, Suwon-si (KR)

Correspondence Address: F. CHAU & ASSOCIATES, LLC, 130 WOODBURY ROAD, WOODBURY, NY, 11797, US

(21) Appl. No.: 12/257,846

(22) Filed: Oct. 24, 2008

(30) Foreign Application Priority Data
Oct. 26, 2007 (KR) 10-2007-0108409

(51) Int. Cl. G06F 12/00

(52) U.S. Cl. 707/205; 707/E17.01

(57) ABSTRACT

A system and method of managing files and a memory device are provided. The system for managing files includes an attribute-management module designating nested attributes to the files having a size smaller than a basic allocation unit of a file system or to directories to which the files belong, a data-management module adjacently nesting the files to which the nested attributes are designated by the attribute-management module with no empty space between the files, and a metadata-management module writing start offsets of the files nested by the data-management module in metadata of the files.

### CROSS-REFERENCE TO RELATED APPLICATION

This application is based on and claims priority from Korean Patent Application No. 10-2007-0108409 filed on Oct. 26, 2007 in the Korean Intellectual Property Office, the disclosure of which is incorporated herein in its entirety by reference.

### BACKGROUND OF THE INVENTION

1. Field of the Invention

The present invention relates to a system and method of managing files and a memory device, and, more particularly, to a system and method of managing files and a memory device that can adjacently store files having a size smaller than a basic allocation unit of a file system.

2. Description of the Prior Art

A file system refers to a method of storing and configuring computer files so as to facilitate the search and access of such files and data stored in the files. A file system is defined as an abstract data structure for hierarchical storing, searching, accessing, and manipulating data.

Recently, with the price fall per byte of NAND flash memories, and an abrupt increase in storage capacity, the storage capacities of diverse built-in type systems, such as portable phones, smart phones, MP3 players, and so forth, have be abruptly increased. Accordingly, rapid input/output of data is possible, and the importance of a file system that secures data integrity is gradually increasing.

Although built-in type systems adopt diverse operating systems, such as WinCE, Linux, Vxworks, Symbian, Nucleus, and so forth, depending on the kind and characteristics of the systems, most of them use a FAT (File Allocation Table) compatible file system for compatibility with PCs.

The term “FAT (File Allocation Table)” means a area for writing file position information of a hard disk in a Microsoft MS-DOS file system.

The FAT file system manages file data in the unit of a cluster, and writes clusters allocated in a certain file in the FAT in the form of a chain. Here, metadata related to respective files, such as information regarding a file name, a file creation time, a file size, a start cluster number of a file, a file attribute, and so forth, are stored in a directory entry of the file.

In addition to the FAT file system, there exists the diverse file systems of Unix, Linux, NTFS, HFS, ext2, ISO 9660, ODS-5, UDF, ZFS, SYSV, EXT2/3, FFS, and so forth, on which diverse papers have been published.

In a general file system, n sectors are tied up in a bundle using a cluster or a block that is a basic allocation unit. In the case of storing a small file, a cluster or block is allocated to the file, and the contents of the file are stored. If a cluster is composed of 2048 bytes and the contents to be stored in the file is composed of 1000 bytes, a cluster is allocated to the file, but 1048 bytes of the cluster is in unused state. That is, in spite of a large amount of usable space remaining in the cluster, a cluster is used only for a file, and since clusters do not share data according to the file system policy, waste of storage space occurs.

Particularly, since small files are frequently used for the purpose of system files in a built-in system, there exists many files which are used only for a read-only operation. If the size of the cluster is decreased to reduce the waste of storage space, the lifespan of an MLC (Multi Level Cell) flash memory is shortened. This is because the MLC page unit, which is the basic unit for a read/write operation and is of 2048 bytes, cannot be modified in a flash operation, and if this unit is set to a smaller one, another physical block is allocated for programming. Accordingly, the read/write operation is frequently performed to shorten the lifespan of the flash memory.

### SUMMARY OF THE INVENTION

Accordingly, the present invention has been made to solve the above-mentioned problems occurring in the prior art, and an object of the present invention is to provide a system and method of managing files and a memory device that can effectively store files having a size smaller than a basic allocation unit of a file system.

Another object of the present invention is to provide a system and method of managing files and a memory device that can reduce a waste of storage space by removing an empty space between files having a size smaller than a basic allocation unit of a file system.

Additional advantages, objects, and features of the invention will be set forth in part in the description which follows and in part will become apparent to those having ordinary skill in the art upon examination of the following or may be learned from practice of the invention.

In order to accomplish these objects, there is provided a system for managing files, according to embodiments of the present invention that includes an attribute-management module designating nested attributes to the files having a size smaller than a basic allocation unit of a file system or to directories to which the files belong; a data-management module adjacently nesting the files to which the nested attributes are designated by the attribute-management module with no empty space between the files; and a metadata-management module writing start offsets of the files nested by the data-management module in metadata of the files.

In another aspect of the present invention, there is provided a method of managing files that includes designating nested attributes to the files having a size smaller than a basic allocation unit of a file system or to directories to which the files belong; adjacently nesting the files to which the nested attributes are designated with no empty space between the files; and writing start offsets of the nested files in metadata of the files.

In still another aspect of the present invention, there is provided a memory device, which includes a data area in which data of files having a size smaller than a basic allocation unit of a file system is adjacently stored with no empty space between the files; and a metadata area in which metadata including start offsets of the files is written.

### BRIEF DESCRIPTION OF THE DRAWINGS

The above and other objects, features and advantages of the present invention will be apparent from the following detailed description taken in conjunction with the accompanying drawings, in which:

FIG. 1 is a view schematically illustrating a method of managing files according to an embodiment of the present invention;

FIG. 2 is a block diagram illustrating the construction of an apparatus for managing files according to an embodiment of the present invention;

FIG. 3 is a view explaining file nesting in a method of managing files according to an embodiment of the present invention;

FIG. 4 is a view explaining the change of a file system 160 due to file nesting in a method of managing files according to an embodiment of the present invention;

FIG. 5 is a view explaining a file nesting in a method of managing files according to another embodiment of the present invention;

FIG. 6 is a view explaining a file nesting in a method of managing files according to still another embodiment of the present invention;

FIG. 7 is a flowchart illustrating a file-nesting method in a method of managing files according to an embodiment of the present invention;

FIG. 8 is a flowchart illustrating a method of reading nested files in a method of managing files according to an embodiment of the present invention; and

FIG. 9 is a flowchart illustrating a method of modifying nested files in a method of managing files according to an embodiment of the present invention.

### DETAILED DESCRIPTION OF THE PREFERRED EMBODIMENTS

Hereinafter, preferred embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

The present invention will be described herein with reference to the accompanying drawings illustrating block diagrams and flowcharts for explaining a system and method of managing files and a memory device according to embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Also, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in reverse order depending upon the functionality involved.

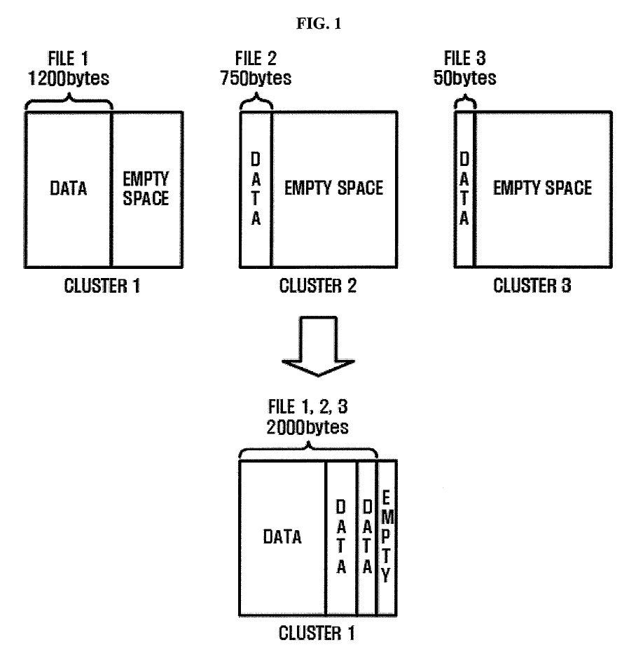

FIG. 1 is a view schematically illustrating a method of managing files according to an embodiment of the present invention.

In FIG. 1, each cluster is a basic allocation unit of a file system according to an embodiment of the present invention, and has a size of 2048 bytes. File 1, file 2, and file 3 are files having a size smaller than that of the cluster. By a method of managing files according to an embodiment of the present invention, file 1, file 2, and file 3 are adjacently nested without any empty space among them.

Accordingly, nested attributes are designated to the files to be nested, and start offsets of the respective files should be written in metadata of the files.

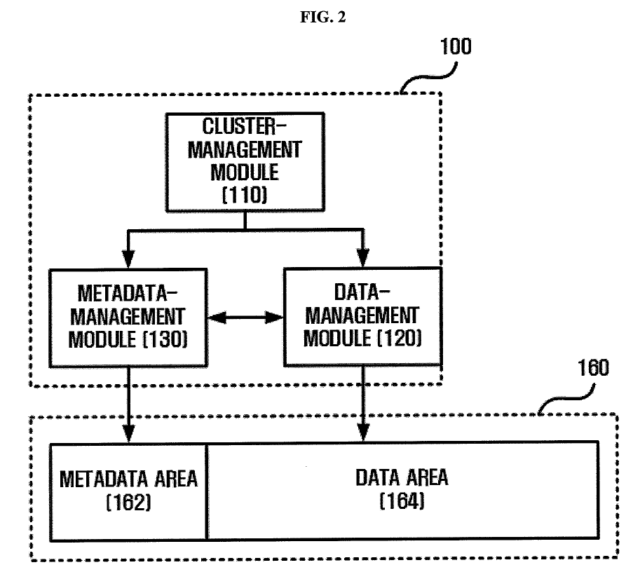

FIG. 2 is a block diagram illustrating the construction of an apparatus for managing files according to an embodiment of the present invention.

The apparatus 100 for managing files according to an embodiment of the present invention includes an attribute-management module 110, a data-management module 120, a metadata-management module 130, and a data-management module 120. Generally, the apparatus 100 for managing the files may be constructed as a part of an operating system that manages a file system, or may be constructed in combination with a CPU (Central Processing Unit).

A file system 160 according to an embodiment of the present invention, which is managed by the apparatus 100 for managing files, includes a metadata area 162 and a data area 164. The file system 160 is created in a memory device such as a hard disk, a diskette, a flash memory, and so forth.

The attribute-management module 110 manages general file attributes, such as read-only, concealment, user authority, and so forth.

The attribute-management module 110 manages nested attributes in files or directories. The attribute-management module 110 designates the nested attributes to the files having a size smaller than that of the basic allocation unit of the file system 160, or to the directories to which the files belong. Since the cluster that is the basic allocation unit of the file system 160 according to an embodiment of the present invention has a size of 2048 bytes, the nested attributes are designated to the files having a size smaller than that of the cluster and to the directories including the files. The files, to which the nested attributes are designated, are system files of operating systems, and are designated by a system designer or automatically designated according to the size of the files.

In addition, the attribute-management module 110 judges whether the attribute of the directory is the nested attribute when the file or directory is read, modified, or deleted.

The data-management module 120 manages the data area 164 of the file system 160. The data-management module 120 serves to read, write, modify and delete the files.

The data-management module 120 adjacently nests the files, i.e., the nested attribute files, to which the nested attributes are designated by the attribute-management module 110 without any empty space among the files. In an embodiment of the present invention, the data-management module 120 adjacently copies or writes data of other nested attribute files based on the first file among the nested attribute files. In another embodiment of the present invention, the data-management module 120 creates big files that are files to be nested, and then copies or writes data of the nested attribute files adjacently to the big files.

In the case of modifying the nested attribute files, the data-management module 120 judges whether the size of the file to be modified is within the original file size. If the size of the file to be modified is larger than the original file size, it is impossible to modify the file according to the characteristic of the nested attribute files. Although the nested attribute files have limitations in modifying the data, there is a small possibility of modification since they are mostly system files. Even if the nested attribute files are modified, their size is not significantly changed to cause problems.

The metadata-management module 130 manages the metadata area 162 of the file system 160. The metadata-management module 130 manages file sizes, the number of allocated clusters, cluster chain lists, or cluster numbers, which are general metadata of the file.

In an embodiment of the present invention, if the nested attribute files are nested, the metadata-management module 130 writes a start offset and a new cluster number in the metadata area 162. Also, the metadata-management module 130 updates the metadata when a new nested attribute file is written, deleted, or modified, and reads the metadata when the nested attribute file is read. In another embodiment of the present invention, the metadata-management module 130 is created in the metadata of the big file that is the file to be nested, and writes the number of references that is the number of nested attribute files and cluster chain lists of the respective nested attribute files.

In the embodiments of the present invention, the term “module”, as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented so as to execute one or more CPUs in a device or a security multimedia card.

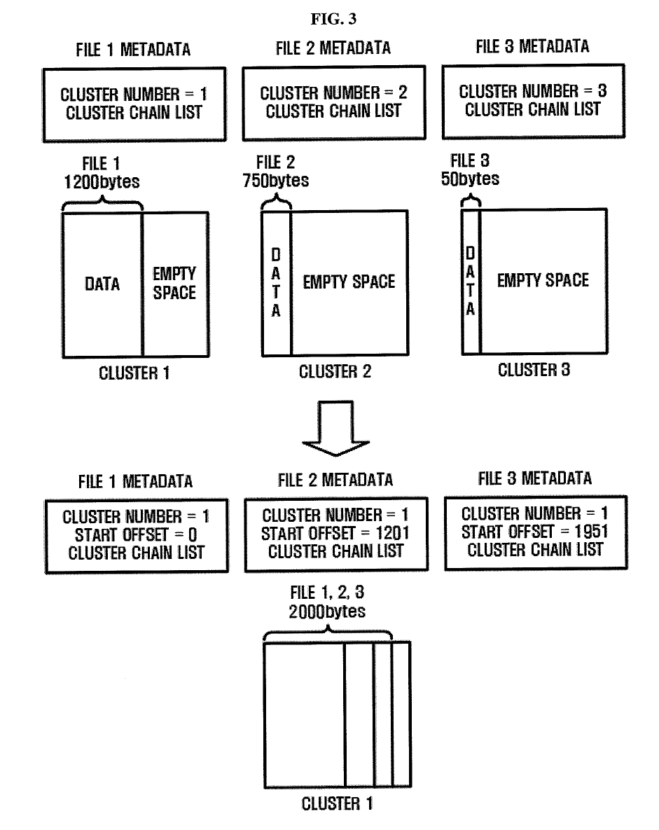

FIG. 3 is a view explaining file nesting in a method of managing files according to an embodiment of the present invention.

File 1, file 2, and file 3 have sizes of 1200 bytes, 750 bytes, and 50 bytes, respectively. Data of file 1, file 2, and file 3 are stored in cluster 1, cluster 2, and cluster 3, respectively. Cluster numbers and cluster chain lists designated to the respective files are stored in metadata of the respective files,.

Since the sizes of file 1, file 2, and file 3 are smaller than the size of the cluster that is composed of 2048 bytes, the nested attributes are designated to the files by the attribute-management module 110. If the nested attributes are designated, the data-management module 120 copies and writes data of file 2 and file 3 in cluster 1 that follows data of file 1.

If file 1, file 2, and file 3 are nested, the metadata-management module 130 writes start offsets of the respective files and a new cluster number, i.e., cluster 1, in the metadata of the respective files existing in the metadata area 162 of the file system 160.

In the case of reading the nested file through the above-described process, the attribute-management module 110 judges whether the file to be read is the nested attribute file. If the file is the nested attribute file, the metadata-management module 130 reads the cluster number and the start offset from the metadata of the file to be read. The data-management module 120 reads data from the corresponding position through the cluster number and the start offset.

In the case of writing a new file in the nested file, the metadata-management module 130 reads the cluster number and the current start offset. The data-management module 120 writes data of the file to be added in the last position written up to now on the basis of the cluster number and the start offset. If the storage space is insufficient, clusters as many as needed are allocated. If the data writing is completed, the metadata-management module 130 writes the start offset and the cluster number in the metadata of the file to be added.

In the case of deleting the nested file, the attribute-management module 110 judges whether the attribute of the file to be deleted is the nested attribute. If the file to be deleted is the nested attribute file, the metadata-management module 130 deletes the metadata of the file to be deleted, and also deletes the directory entry from the directory to which the corresponding file belongs.

In the case of modifying the nested file, the attribute-management module 110 judges whether the attribute of the directory to which the corresponding file belongs or the attribute of the corresponding file is the nested attribute. If the file to be modified is the nested attribute file, the data-management module 120 judges whether the size of the file to be modified is within the original file size. If the size of the file to be modified is larger than the original file size, it is impossible to modify the file. If the size of the file to be modified is equal to or smaller than the original file size, the data-management module 120 modifies the data of the corresponding file. As described above, although the nested attribute files have limitations in modifying the data, there is a small possibility of modification since they are mostly system files. Even if the nested attribute files are modified, their file size is not significantly changed, which causes a problem.

Preferably, if the nested attribute is designated to the directory, all files belonging to the nested attribute directories and the directories are nested. However, clusters allocated for the purpose of the directory entry are excluded from the nesting. The nesting and management method is as described above.

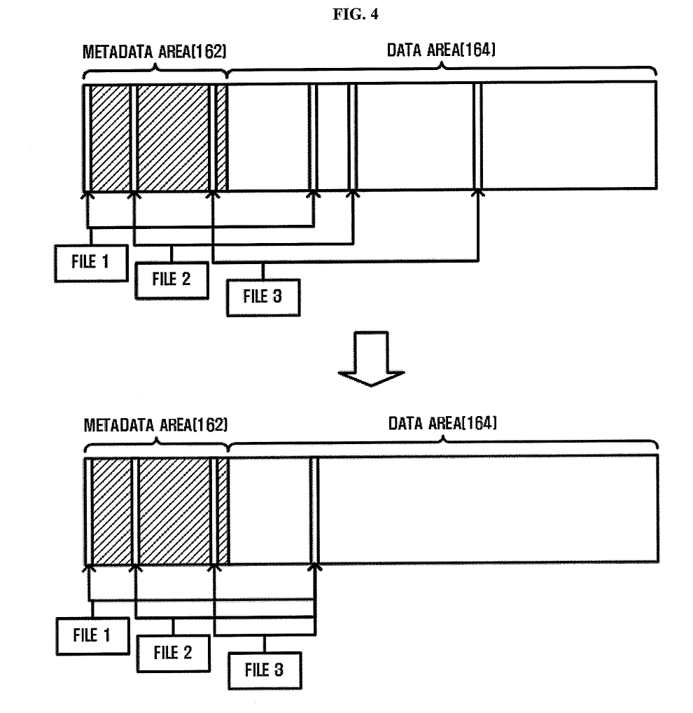

FIG. 4 is a view explaining the change of a file system 160 due to file nesting in a method of managing files according to an embodiment of the present invention.

Before the nesting, file 1, file 2, and file 3 have metadata stored in the metadata area 162, data of the files is stored in respective clusters of the data area 164.

After the nesting, file 1, file 2, and file 3 have the metadata stored in the metadata area 162, and the data is stored in one cluster of the data area 164. Accordingly, much more data area 164 is secured.

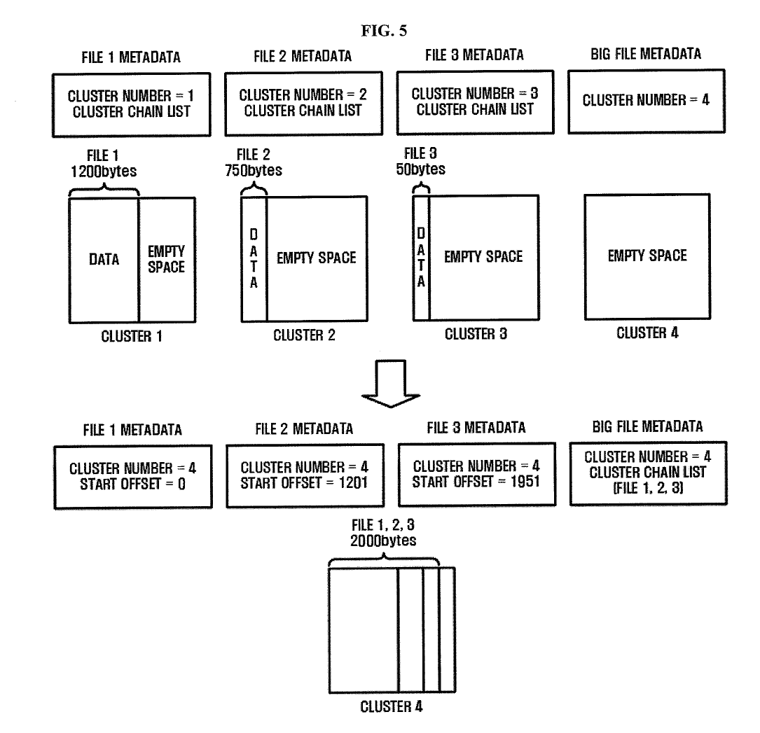

FIG. 5 is a view explaining a file nesting in a method of managing files according to another embodiment of the present invention.

File 1, file 2, and file 3 have sizes of 1200 bytes, 750 bytes, and 50 bytes, respectively. Data of file 1, file 2, and file 3 are stored in cluster 1, cluster 2, and cluster 3, respectively. Cluster numbers and cluster chain lists designated to the respective files are stored in metadata of the respective files.

Since the sizes of the file 1, file 2, and file 3 are smaller than the size of the cluster that is composed of 2048 bytes, the nested attributes are designated to the files by the attribute-management module 110. If the nested attributes are designated, the data-management module 120 allocates a big file to a new cluster 4, and the metadata-management module 130 creates metadata of the big file. The number of clusters and the file size of the big file are set to “0”, and the number of references that indicates how many files refer to the big file is set to “0”, which is an initial value.

If a big file is prepared, the data-management module 120 copies and writes data of file 1, file 2, and file 3 in the data area allocated to the big file.

If file 1, file 2, and file 3 are nested, the metadata-management module 130 writes start offsets of the respective files and the new cluster number, i.e., cluster 4, in the metadata of the respective files existing in the metadata area 162 of the file system 160. The metadata-management module 130 writes cluster chain lists of the respective files in the metadata of the big file, and writes “3” as the number of references since three files are nested.

In the case of reading the nested file through the above-described process, the attribute-management module 110 judges whether the file to be read is the nested attribute file. If the file is the nested attribute file, the metadata-management module 130 reads the cluster number and the start offset from the metadata of the file to be read. Also, the metadata-management module 130 reads the cluster chain list from the metadata of the big file. The data-management module 120 reads data from the corresponding position through the cluster number, the start offset, and the cluster chain list.

In the case of writing a new file in the nested file, the metadata-management module 130 reads the cluster number and the start offset written up to now. The data-management module 120 writes data of the file to be added in the last position, on the basis of the cluster number and the start offset. If the storage space in the big file is insufficient, clusters as many as needed are allocated, and the metadata-management module 130 updates the metadata (e.g., the file size and the number of allocated clusters) of the big file. If the data writing is completed, the metadata-management module 130 writes the start offset and the cluster number in the metadata of the file to be added.

In the case of deleting the nested file, the attribute-management module 110 judges whether the attribute of the file to be deleted is the nested attribute. If the file to be deleted is the nested attribute file, the metadata-management module 130 deletes the metadata of the file to be deleted, and also deletes the directory entry from the directory to which the corresponding file belongs. In addition, the metadata-management module 130 reduces the number of references as many as the number of deleted files and writes the reduced number of references in the metadata of the big file. If the deleted file is the last part of the big file, the metadata-management module 130 updates the metadata (i.e., the file size and the number of allocated clusters) of the 1big file.

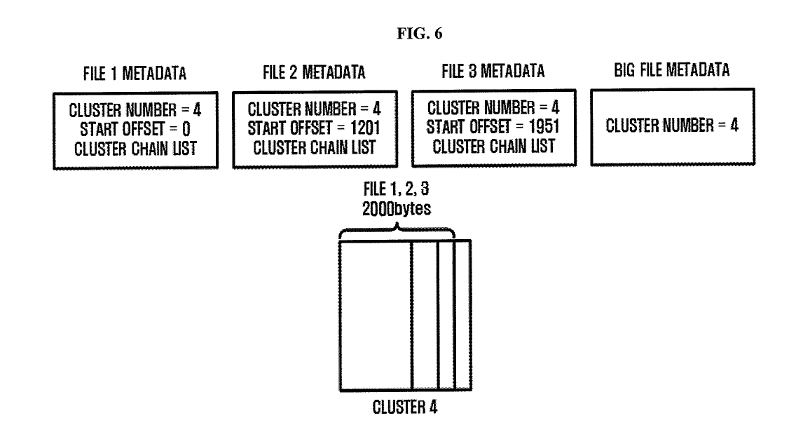

FIG. 6 is a view explaining a file nesting in a method of managing files according to still another embodiment of the present invention.

The file-nesting method according to still another embodiment of the present invention is similar to the file-nesting method using a big file as illustrated in FIG. 5 except that cluster chain lists are written in the metadata of respective files rather than in the metadata of the big file.

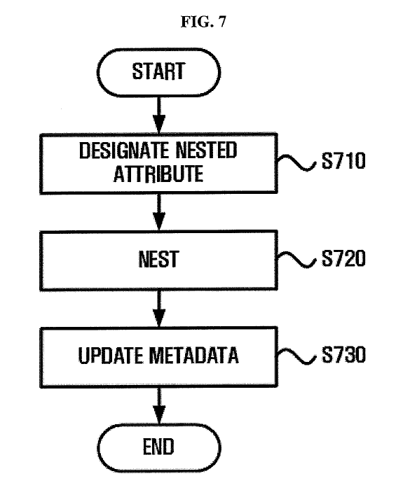

FIG. 7 is a flowchart illustrating a file-nesting method in a method of managing files according to an embodiment of the present invention.

Nested attributes are designated to files or directories S710. The attribute-management module 110 designates the nested attributes to the files having a size smaller than that of the basic allocation unit of the file system 160, or to the directories to which the files belong. Since the cluster that is the basic allocation unit of the file system 160 according to an embodiment of the present invention has a size of 2048 bytes, the nested attributes are designated to the files having a size smaller than that of the cluster and to the directories including the files. The files, to which the nested attributes are designated, are system files of operating systems, and are designated by a system designer or automatically designated according to the size of the files.

The files to which the nested attributes are designated or the files belonging to the directories are nested S720. The data-management module 120 adjacently nests the nested attribute files, to which the nested attributes are designated by the attribute-management module 110, without any empty space among the files. In an embodiment of the present invention, the data-management module 120 adjacently copies or writes data of other nested attribute files based on the first file among the nested attribute files. In another embodiment of the present invention, the data-management module 120 creates big files that are files to be nested, and then copies or writes data of the nested attribute files adjacently to the big files.

If the file nesting is completed, the metadata is updated S730. If the nested attribute files are nested, the metadata-management module 130 writes a start offset and a new cluster number in the metadata area 162. In another embodiment of the present invention, the metadata-management module 130 is created in the metadata of the big file that is the file to be nested, and writes the number of references that is the number of nested attribute files and cluster chain lists of the respective nested attribute files.

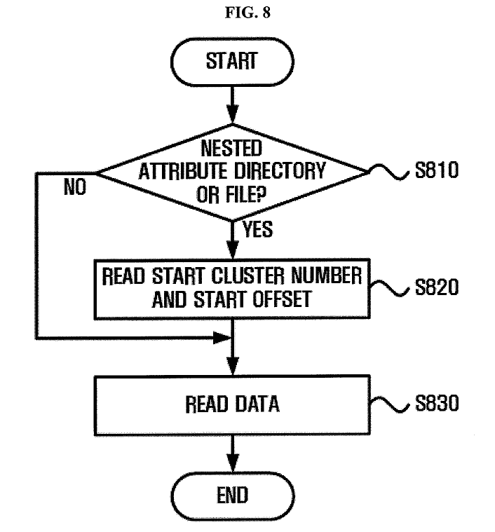

FIG. 8 is a flowchart illustrating a method of reading nested files in a method of managing files according to an embodiment of the present invention.

It is determines whether the directory or file to be read is the nested attribute directory or file S810. The attribute-management module 110 determines whether the directory to which the file belongs or the file to be read is the nested attribute directory or file, and if the directory or file is not the nested attribute directory or file, the metadata-management module 130 reads the data with reference to the metadata through a general method of reading files.

If the directory or file is the nested attribute directory or file, the start cluster number and the start offset are read S820. In an embodiment of the present invention, the metadata-management module 130 reads the cluster number and the start offset from the metadata of the file to be read. In another embodiment of the present invention, t metadata-management module 130 reads the cluster chain list from the metadata of the big file.

The data is read through the start cluster number and the start offset S830. The data-management module 120 reads the data from the corresponding position through the cluster number and the start offset.

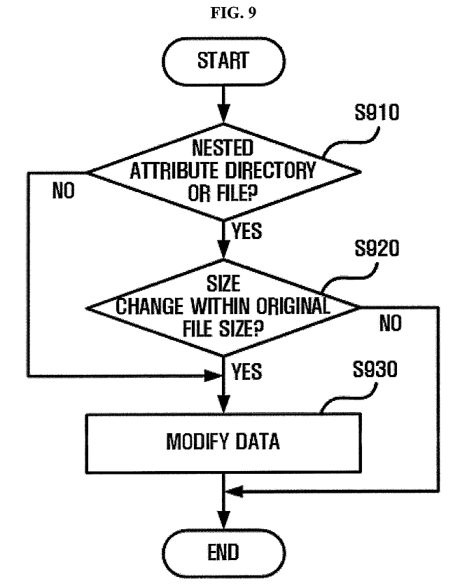

FIG. 9 is a flowchart illustrating a method of modifying nested files in a method of managing files according to an embodiment of the present invention.

It is determined whether the directory or file to be modified is the nested attribute directory or file S910. The attribute-management module 110 judges whether the attribute of the directory to which the corresponding file belongs or the attribute of the corresponding file is the nested attribute. If the directory or file to be modified is not the nested attribute directory or file, the data-management module 120 modifies the data with reference to the metadata through a general method of modifying files.

If the directory or file to be modified is the nested attribute directory or file, the data-management module 120 determines whether the size of the file to be modified is within the original file size S920. If the size of the file to be modified is larger than the original file size, it is impossible to modify the file, and thus the data-management module 120 ends the modification of the nested files. In this case, it is preferable that an error message is outputted. As described above, although the nested attribute files have limitations in modifying the data, there is a small possibility of modification since they are mostly system files. Even if the nested attribute files are modified, their file size is not greatly changed to cause a problem.

If the size of the file to be modified is equal to or smaller than the original file size, the data is modified S930. Preferably, the metadata-management module 130 reads the metadata, and the data-management module 120 modifies the data of the corresponding file according to the metadata.

As described above, the apparatus and method of managing files and the memory device according to the present invention produce one or more of the following effects.

First, an empty space between files having a size smaller than the basic allocation unit of the file system is removed, and thus the waste of storage space is reduced.

Second, the files having a size smaller than the basic allocation unit of the file system can be effectively stored.

Third, it is not required to adjust the size of the basic allocation unit of the file system.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A system for managing files, comprising:
an attribute-management module designating nested attributes to the files having a size smaller than a basic allocation unit of a file system or to directories to which the files belong;
a data-management module adjacently nesting the files to which the nested attributes are designated by the attribute-management module with no empty space between the files; and
a metadata-management module writing start offsets of the files nested by the data-management module in metadata of the files.

2. The system of claim 1, wherein the file system comprises:
a metadata area in which the metadata is written; and
a data area in which data of the files is written.

3. The system of claim 1, wherein the attribute-management module judges whether the files or directories to which the files belong are the nested attribute files or directories when the files are read, written, modified, or deleted.

4. The system of claim 1, wherein the data-management module reads, writes, modifies, or deletes the files.

5. The system of claim 1, wherein the data-management module compares sizes of the files to be modified with an original file size when the nested files are modified.

6. The system of claim 1, wherein the metadata-management module writes cluster numbers of the nested files in metadata of the files.

7. The system of claim 1, wherein the metadata-management module manages sizes of the files written in the metadata of the nested files, the number of allocated clusters, and cluster chain lists.

8. The system of claim 1, wherein the data-management module creates big files that are files to which the nested attribute files are to be nested, and nests the files.

9. The system of claim 8, wherein the metadata-management module writes the number of references, which is the number of nested files, in metadata of the big files.

10. The system of claim 8, wherein the metadata-management module writes cluster chain lists of the nested files in the metadata of the big files.

11. A method of managing files, comprising:
designating nested attributes to the files having a size smaller than a basic allocation unit of a file system or to directories to which the files belong;
adjacently nesting the files to which the nested attributes are designated with no empty space between the files; and
writing start offsets of the nested files in metadata of the files.

12. The method of claim 11, wherein the file system comprises:
a metadata area in which the metadata is written; and
a data area in which data of the files is written.

13. The method of claim 11, further comprising:
judging whether attributes of the nested files or the directories to which the files belong are the nested attributes;
reading the start offsets from the metadata of the files judged as the nested attribute files; and
reading data of the files through the read start offsets.

14. The method of claim 11, further comprising:
determining whether attributes of the nested files or the directories to which the files belong are the nested attributes;
comparing sizes of the nested attribute files with sizes of files to be modified; and
modifying data of the files if the sizes of the files to be modified are smaller than or equal to the original file size.

15. The method of claim 11, further comprising:
reading the start offsets from the metadata of the nested files;
writing new file data in a position where data is lastly written through the read start offsets; and
writing a start offset of the new file in metadata of the new file.

16. The method of claim 11, further comprising:
determining whether attributes of the nested files or directories to which the files belong are the nested attributes; and
deleting metadata of the files judged as the nested attribute files.

17. The method of claim 11, wherein the nesting further comprises nesting the files after creating big files that are files to which the nested attribute files are to be nested, and writing the number of references, which is the number of the nested files, in metadata of the big files.

18. The method of claim 17, further comprising writing cluster chain lists of the nested files in the metadata of the big files.

19. The method of claim 17, further comprising:
judging whether attributes of the nested files or the directories to which the files belong are the nested attributes;
reading the start offsets from the metadata of the files judged as the nested attribute files, and reading the cluster chain lists from metadata of the big files; and
reading data of the files through the read start offsets and the cluster chain lists.

20. The method of claim 17, further comprising:
judging whether attributes of the nested files or the directories to which the files belong are the nested attributes;
deleting metadata of the files judged as the nested attribute files; and
updating the number of references in metadata of the big files.

21. A memory device comprising:
a data area in which data of files having a size smaller than a basic allocation unit of a file system is adjacently stored with no empty space between the files; and
a metadata area in which metadata including start offsets of the files is written.

22. The memory device of claim 21, wherein the adjacently stored files have nested attributes.

23. The memory device of claim 21, wherein the adjacently stored files are managed as big files, and the metadata area comprises metadata of the big files in which the number of references, which is the number of the adjacently stored files, is written.
